(19) United States
(12) Patent Application Publication
(10) Pub. No.: US 2011/0311782 A1
(43) Pub. Date: Dec. 22, 2011

(54) PLANAR COMPONENT OF AN AIRCRAFT AND METHOD FOR PRODUCING THE SAME

(76) Inventors: Nolan Richmond, Munich (DE); Thomas Ritschel, Munich (DE)

(21) Appl. No.: 13/130,968

(22) PCT Filed: Nov. 24, 2009
(86) PCT No.: PCT/EP2009/065764

§ 371 Date: Sep. 7, 2011

(30) Foreign Application Priority Data
Nov. 28, 2008 (DE) 10 2008 059 653.1

(51) Int. Cl. B32B 3/08; B32B 38/08; B32B 38/18

(52) U.S. Cl. 428/172; 156/199; 156/279; 156/280; 428/189; 428/195.1

(57) ABSTRACT

The invention relates to a planar component (1) of an aircraft (2) which component defines an area (3) having a material thickness (4). In order to increase the dent resistance in at least part of the area or subareas (7) that are defined by webs (5) having a web height (6), at least one reinforcing bead (8) having a bead length (9) extends between the webs (5) across the subarea (7). The invention also relates to a method of production which particularly allows the production of such a planar component in an autoclave.

The present invention relates to a planar component of an aircraft, in particular an airplane or helicopter, which forms a surface area with a material thickness and has webs (stringers and ribs) with a web height which form partial surface areas of the planar component. Such planar components are used in particular as wings, fuselage components, casings of drive units etc. in a lightweight form of construction from fiber-reinforced composite material. In addition, a method for producing such a planar component is provided.

With a view to the efforts to adapt airplanes of the future to ecological requirements and make them inexpensive to produce and operate, while nevertheless complying with the strictest safety regulations, there is increasingly a search for possibilities of no longer producing the essential primary structures (for example wing or fuselage components) from aluminum but from fiber-reinforced composite material. With this lightweight type of construction it is possible in particular to reduce the weight of the airplanes significantly. In the production of such essential primary structures, it must be taken into account that they assume considerable sizes, for example the landing flaps of airplanes are components that extend over several meters. Moreover, these components are subjected to great loads during operation, and consequently represent components that are critical in terms of safety and must comply with particular strength, stiffness and quality requirements.

Such fiber-reinforced composite materials generally comprise two essential components, one being the fiber and the other being a polymer matrix surrounding the fiber. The polymer matrix encloses the fiber and is hardened for example by a thermal treatment (polymerization), so that a three-dimensional crosslinkage takes place. This polymerization achieves the effect that the fibers are securely bonded to one another, and so forces can be introduced into the fibers, to be specific mainly via shearing stresses. Apart from carbon fibers, glass fibers may also come into consideration as fibers. Carbon fibers, which at the present time are still comparatively expensive, often consist of carbon to at least 90% by weight. The diameter of the fibers is, for example, 4.5 to 8 μm [micrometers]. The properties of such carbon fibers are anisotropic. By contrast with this, glass fibers have an amorphous structure and isotropic properties. They predominantly consist of silicon oxide, possibly admixed with further oxides. While the glass fibers are relatively inexpensive, the carbon fibers are distinguished by their high strength and stiffness.

In airplane construction specifically, the so-called prepreg technique is used. In this technology, preimpregnated woven fabrics or other, even ready-made, semifinished textile products, for example, are impregnated in synthetic resins and thermally treated only until they have slightly solidified (gelled), so that they can be handled in the form of layers. Such a prepreg material has a low level of tack and can consequently be arranged well in corresponding molds or in layers one on top of the other until the desired form of component is obtained. Once the desired layers of the prepreg material and the vacuum setup have been arranged, they can be (thermally) cured. For curing these prepreg components, at present so-called autoclaves are used, that is to say ovens which are heated for hours, possibly under positive pressure (up to 10 bar), in order to achieve complete curing of the evacuated components.

In view of the fact that weight is often a prime concern in the case of such components, but the high requirements for the load-bearing capacity of such components must not be neglected, these large-area components are often reinforced by various types of webs, which is the term used hereafter in particular as a general term for the components referred to in airplane construction as “stringers” and “ribs”. These “stringers” have, for example, a web height in the range of up to 30 mm and extend in a straight line, in particular parallel to one another, in a predetermined direction of extent over the entire surface area of the component. Furthermore, still larger “ribs”, which in the case of cylindrical components are also referred to as frames, are usually also arranged at regular intervals in such a way that, together with the stringers, they lie on the planar component in the manner of a grid and are connected to it. These arrangements of the webs define partial areas of the planar component, that is to say partial areas in which the planar component is often formed substantially only by the layers of the prepreg material. In order to absorb the forces occurring during use here as well, it is necessary to obtain sufficient strengths, for which purpose a corresponding number of layers of the prepreg material are used, which however does not necessarily ensure the required buckling stiffness. For this reason, in the case of relatively large airplane components, a greater number of layers, for example about 30 layers, are often used in order to achieve a sufficient material thickness for them of over 4 mm. If the number of layers were determined only on the basis of strength, a thickness much less than that required for buckling stiffness could be chosen and result in a stability failure, that is to say undesired deformations of the planar component could occur, in particular rising up locally from the surface area in the manner of dents. With monolithic components there is therefore often the risk that they are overdimensioned in terms of strength for reasons of stability, and therefore the potential of lightweight construction is not fully utilized.

On this basis, it is an object of the present invention to solve at least partially the problems described with reference to the prior art. In particular, it is intended to provide a planar component which is reduced in terms of weight, but at the same time is improved in terms of buckling resistance. Moreover, it is intended to provide a simple, inexpensive method for producing such planar components.

These objects are achieved by a planar component according to the features of claim 1 and a method for producing a planar component of an aircraft according to the features of claim 7. Further advantageous embodiments of the invention are specified in the respectively dependently formulated claims. It should be pointed out that the features individually presented in the claims can be combined with one another in any technologically meaningful way and present further embodiments of the invention. The description, in particular also in conjunction with the figures, explains the invention and provides additional exemplary embodiments.

The invention accordingly relates to a planar component of an aircraft, made of fiber-reinforced composite material, which forms a surface area with a material thickness and is configured with at least one reinforcing bead of a predetermined bead extent, the extent of the bead being at most 10 mm.

The planar component serves in particular for constructing an airfoil or tail surface and/or an outer skin of an aircraft, it also being possible for the planar component itself to be arranged or integrated within these aircraft components. With regard to the materials, reference is made here to the introductory remarks. The provision of a reinforcing bead, which is likewise produced with fiber-reinforced composite material, increases the stability of the planar component. In this case, the reinforcing beads are not comparable with the known stringers or ribs, which are configured as surface areas that are perpendicular to the planar component and have a minimum extent of 20 mm to 30 mm. The reinforcing bead, by contrast, has substantially no planar structure, but instead rather more of a thick, round, oval cross section in the manner of a bead. At least the maximum extent of the bead in a direction perpendicular to the surface area or in the direction of the material thickness is accordingly 10 millimeters or even at most 5 millimeters.

The planar aircraft component according to the invention, made of fiber-reinforced composite material, is more preferably produced in such a way that it forms a surface area with a material thickness and has webs with a web height which form partial areas of the planar component, at least one partial area being configured with at least one reinforcing bead of a bead extent which extends over the partial area between the delimiting webs.

This planar component is, in particular, a component made of fiber-reinforced composite material such as that explained at the beginning. Reference is also made to the introduction with regard to the arrangement of the webs and their design. In order now to counteract the stability failure (buckling) and at the same time make a thin monolithic material thickness possible, a reinforcing bead is provided for at least one partial area, possibly even for all the partial areas. It may also be possible to integrate a number of reinforcing beads in one partial area. In principle, such a reinforcing bead extends over the partial area, the reinforcing bead extending with particular preference from one corner region of the partial area to an opposite corner region of the partial area. In the event that a number of reinforcing beads are provided, they may at least partially be arranged parallel to one another and/or at an angle to one another. In addition, it is also possible to form with the reinforcing beads a kind of truss and/or pattern, which in particular is regular, so that the intermediate regions between the reinforcing beads are therefore approximately the same size. The reinforcing beads are preferably only formed toward one side of the planar component, that is for example the side on which the webs are also arranged. The bead extent, that is to say for example the diameter of the reinforcing bead, is made much smaller than the web height (in particular with respect to the stringers), is therefore for example at most 15% of the web height of the webs surrounding the partial areas. The reinforcing beads consequently form locally thickened regions of the planar component that counteract buckling. The other regions of the partial areas may be made with a reduced material thickness. As a result, with this type of construction weight savings of up to 30% can be achieved with the same buckling characteristics in comparison with the planar component of a monolithic type of construction without the reinforcing beads.

According to a preferred configurational variant of the planar component, at least the surface area and the at least one reinforcing bead are of a monolithic configuration. The surface area, which represents in particular the so-called “skin” of the planar component, is thus produced, for example, with the layers of the prepreg material from a carbon fiber-reinforced composite material. The reinforcing bead is also in this case formed from a carbon fiber-reinforced composite material. Within the production process, these elements are then bonded to one another and cured, respectively, in such a way that they no longer show any significant sign of a material transition, that is to say they are in particular of a monolithic form (also in other words are in one piece). Even if it is possible in principle to provide the surface area and the at least one reinforcing bead with material that is different from one to the other, it is however desired here for the materials to match each other, at least to a great extent. In particular, the reinforcing bead has the same material as the surface area to at least 90% by weight.

In addition, it is regarded as advantageous that a number of reinforcing beads of a partial area are superposed. This means in other words, in particular, that the reinforcing beads (normally arranged in a straight line) cross. This allows the overall extent of the beads in the region where two reinforcing beads are superposed to be increased (for example approximately doubled), but it is also possible for one reinforcing bead to run toward the other and be reduced in the region where they are superposed in such a way that the overall extent of the superposed reinforcing beads corresponds approximately to the extent of a single reinforcing bead. Furthermore, it is preferred that at least one such region with superimposed reinforcing beads is provided in a partial area.

Furthermore, it is regarded as advantageous here that the bead extent corresponds at least to the material thickness (is equal or greater) and is less than the web height. With regard to the material thickness, a range that is for example less than 3.5 mm, thus for example even less than 3 mm and, in particular, approximately 2 mm, is regarded as advisable here. The material thickness is formed by a corresponding (reduced) number of layers of the prepreg material.

As already explained at the beginning, the webs (stringers) have a web height of more than 20 mm on average, thus for example approximately 30 mm. It is now proposed here that the bead extent is arranged in the intermediate range with regard to the material thickness and the web height. Most particularly preferred in this respect is a bead extent which is at least twice the material thickness, possibly even at least five times or even ten times the material thickness. A reinforcing bead with an approximately semicircular cross section has been most particularly suitable. In this case, the bead extent in the direction of the material thickness of the surface area is preferably between 2 and 4 mm. Perpendicular to the material thickness, the bead extent may be, for example, up to 10 mm. It is only for the sake of completeness that it is pointed out here that it is not absolutely necessary for the cross section of the reinforcing beads to be of such a design; instead, adaptations to the respective loads and/or forms of the planar component may also lead here to a different design. It is similarly possible to provide different reinforcing beads with regard to the cross-sectional form and/or the bead extent.

Following an embodiment of the planar component, at least one reinforcing bead is surrounded by a supporting structure. The supporting structure has, in particular, the function of maintaining a desired cross-sectional form or bead extent of the reinforcing bead during the production process (and thereafter). The supporting structure may, for example, be configured in the manner of a woven fabric, mesh or the like and at least partially (but preferably completely) surround the at least one reinforcing bead. Thus, a supporting structure may have, for example, one or more fibers which stabilize the reinforcing bead in terms of its form (at least during production). During production, such a reinforcing bead has, for example, a number of strands of carbon fibers which are bundled in a dry or preimpregnated state. The fibers of the supporting structure may be formed in this case with a different material; glass fibers and/or aramid fibers come into consideration here in particular. This supporting structure can to this extent also be seen as such after the polymerization of the planar component, but is intimately bonded with the material of the surface area and/or of the reinforcing bead.

According to a further aspect of the invention, a method for producing a planar component of an aircraft is also proposed, comprising at least the following steps:
a) forming a surface area by laminating a number of layers of a curable material;
b) arranging at least one reinforcing bead of a curable material on the surface area;
c) curing the surface area and the at least one reinforcing bead together to form a monolithic planar component.

The method provided here according to the invention serves in particular for producing the planar component according to the invention.

In step a), a number of layers of a carbon-reinforced base material are used in particular. The carbon fibers preferably start out as continuous long fibers, which are arranged in the components in a layered manner, possibly with the longitudinal direction of the fibers differing in their alignment. A number of such layers may then be positioned one on top of the other and/or one next to the other on a substrate, so that the surface area is formed, in particular with its curved shape. This surface area may in this case have a size of several square meters and has, in particular, a (slightly) bent form. The forming of the laminate takes place in particular in a one-sided mold, which forms the desired contour or shape of the surface.

Together with step a), or else after it, the reinforcing beads (in the cured or uncured state) are then arranged on the surface area. In principle, it is possible for the webs to be formed simultaneously with step a) and/or b), but that is not absolutely necessary. Thus, the webs may also be subsequently fastened (adhesively attached) to the cured component. The reinforcing beads are in this case arranged with the alignment described above or the pattern explained to meet the desired requirements of the planar component. Here it should also be pointed out that the layers and/or the reinforcing bead may possibly also be separately treated (for example impregnated), in order finally to be curable. Consequently, the term “curable material” possibly also includes an intermediate product which is (still) not impregnated, such as a dry textile semifinished product or strands of carbon fiber, glass fiber or aramid fiber.

The curing of the surface area according to step c) preferably takes place thermally and under a vacuum with positive pressure. On account of the direct contact of the reinforcing bead with the surface area, a monolithic, one-piece form of the planar component is obtained.

A method in which the at least one reinforcing bead is provided by at least one of the following processes is also regarded as advantageous:
twisting a plurality of strands of the curable material;
bundling a number of strands of the curable material;
fixing a plurality of strands of the curable material in relation to one another;
arranging a plurality of strands of the curable material on a supporting structure.

The processes cited above are aimed in particular at simplifying the handling of the reinforcing beads during production and/or substantially retaining the form (in cross section or in the longitudinal direction) of the reinforcing beads even during the curing. It is thus proposed here, for example, to provide the reinforcing bead with a plurality of strands (preferably of carbon fibers) which are twisted with respect to one another. In some cases, it may also be advisable for the strands to be fixed with one another, for example in the manner of a woven fabric. In addition, it is also possible for a number of strands of the curable material to be bundled to form the reinforcing beads, is also being possible for this perhaps to be performed by means of suitable adhesive agents. The number of strands should in this case be chosen with a view to the desired shape of the reinforcing beads on the surface area of the planar component. If required, additional means could also be used in order to fix the plurality of strands of the curable material in relation to one another, it being possible for these means to be made with the same material of the strands or a likewise suitable material. Finally, it is also advantageous to keep the plurality of strands exactly in the desired form by means of a suitable supporting structure, while this supporting structure should specifically not adversely affect step c) described above. The supporting structure may thus also be configured, for example, as a mesh surrounding the strands or else as fixing fibers to a textile base structure (of curable material, carbon fibers, glass fibers or aramid fibers).

Furthermore, it is also regarded as advantageous that the curable materials of the layers and of the at least one reinforcing bead are impregnated with resin in steps a) and b). This also means in other words that so-called prepreg materials are used here in particular, that is to say woven fabrics or other fibrous forms of carbon fibers (preforms) which are impregnated in synthetic resin. One of the following comes into consideration in particular as the resin: epoxy resin, phenolic resin, bismaleinimide resin or polyester resin.

In particular, it is regarded as advantageous that step c) is carried out in an autoclave. This opens up the possibility of resorting to known technologies and tools for the production of such planar components. In any case, many other processes may be used here for the production, mention being made by way of example of infiltration processes such as RTM (resin transfer molding) or VARI (vacuum assisted resin infiltrated).

The advantages of the invention, in particular the reduced weight of the planar component, can be seen in particular in the case of an aircraft, having at least one planar component of the type described here according to the invention, which is possibly produced by the method of production according to the invention. A passenger airplane or a helicopter comes into consideration in particular as the aircraft.

With the planar component specified here, or the method of production proposed for it, a series of considerable advantages can be achieved. For example, simple testing of the components is possible, in particular a nondestructive analysis by means of ultrasound. Moreover, the production of the planar component can take place in a single operation in an autoclave. In addition, it should also not be neglected that the application of the reinforcing beads with regard to number, type and/or position can be performed on the basis of a particular use or loading (and possibly even automatically).

The invention and the relevant technical field are explained in more detail below on the basis of the figures. It should be pointed out that, although the configurational variants illustrated in the schematic figures are preferred, the invention is not restricted to these. In the figures is schematically shown:

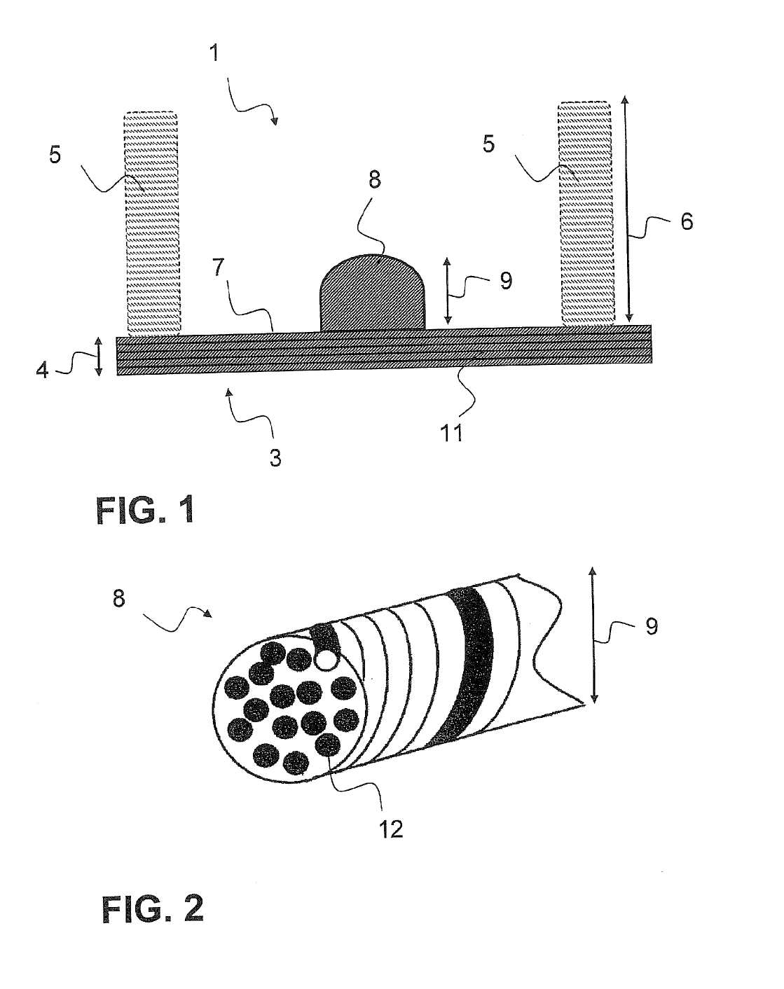

FIG. 1: a partial cross section through a planar component,

FIG. 2: a first configurational variant of a reinforcing bead,

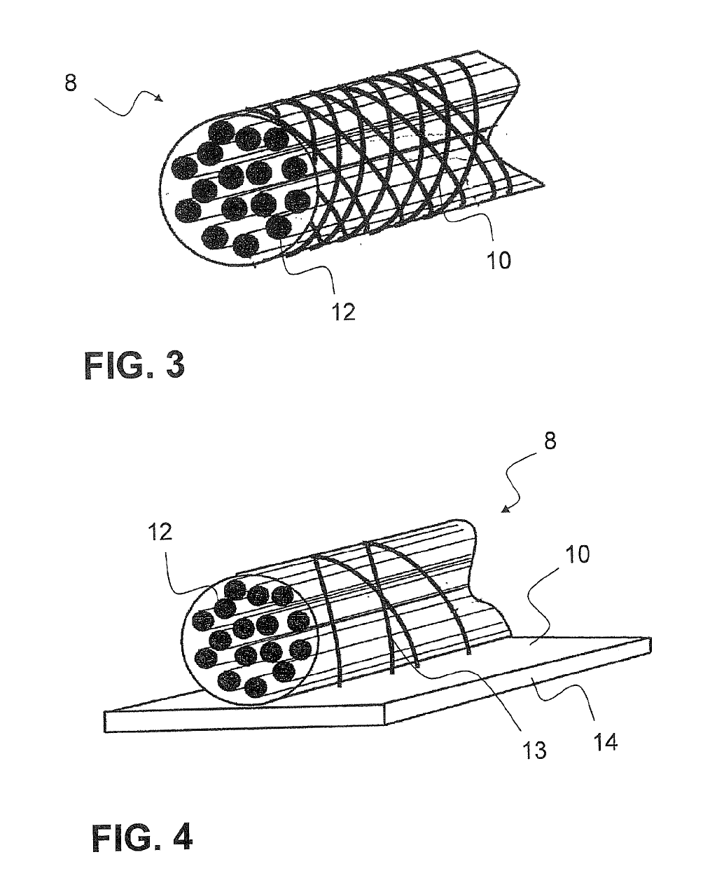

FIG. 3: a second configurational variant of the reinforcing bead,

FIG. 4: a third configurational variant of the reinforcing bead,

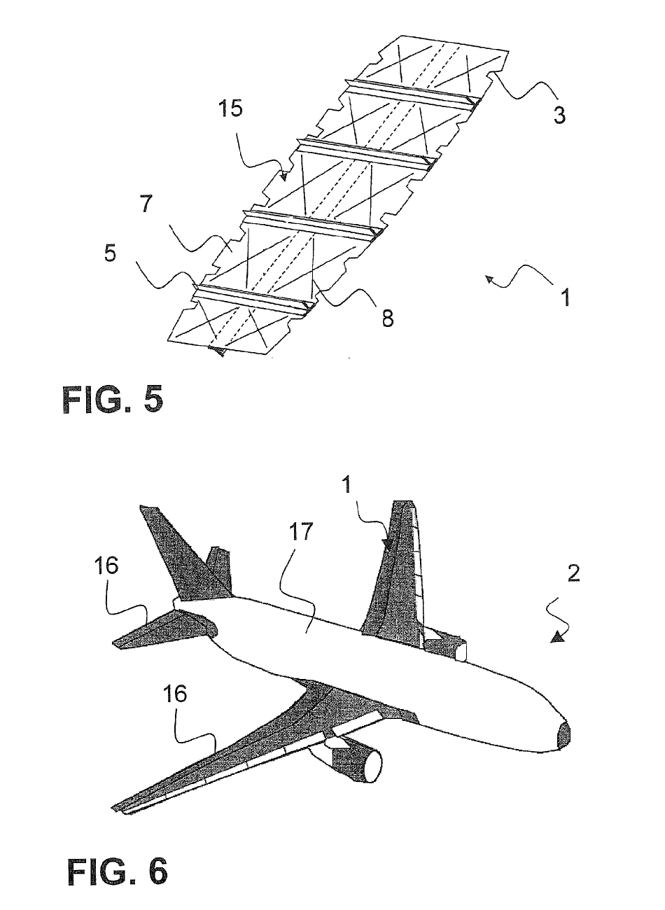

FIG. 5: a perspective representation of a planar component, and

FIG. 6: an aircraft.

FIG. 1 shows schematically and in a cross section a detail of a planar component 1, as it can be used later in an aircraft. Illustrated at the bottom in FIG. 1 is the surface area 3, which however is shown here as cut off on the right and left. The surface area 3 forms, for example, an expanse with the dimensions of 3 m×10 m. To construct or produce this surface area 3, a plurality of layers 11 of preimpregnated woven carbon-fiber fabric are used here. During production, these are arranged one on top of the other and one next to the other, so that ultimately a material thickness 4 of the kind desired is achieved, the material thickness preferably being less than 3.5 mm. Even if the surface area 3 is shown here as substantially planar, it is in fact often curved.

For stiffening the surface area 3, a plurality of webs 5 (stringers), which form a predetermined web height 6, are provided on one side (here at the top). In FIG. 1, the webs 5 are only indicated, this being intended to imply that the webs 5 are, for example, only joined on after joint curing of the reinforcing beads and the layers 11. Nevertheless, the position of these webs 5 with respect to the surface area 3 is known in advance, so that the partial areas 7 between the webs 5 are identifiable. Precisely in these partial areas 7, which for example form dimensions in the range from 300 mm×200 mm, a plurality of reinforcing beads 8 are then preferably provided (even if only a single reinforcing bead 8 is shown here). In FIG. 1, the reinforcing bead 8 runs parallel to the webs 5 and extends over the entire partial area 7. The reinforcing bead 8 has in this case an approximately semicircular cross section with a bead extent 9. Here it can be seen that the bead extent 9 lies in a range which is greater than the material thickness 4 but less than the web height 6.

FIGS. 2, 3 and 4 show various configurational variants of reinforcing beads such as can be used for the production of the planar component. These are, in particular, a plurality of strands 12 of the curable material, in particular (impregnated) carbon fibers. In FIG. 2, the strands 12 are helically twisted with one another and consequently form the desired bead extent 9 on their own. It is clear that a deformation of the reinforcing bead 8 may occur, especially during production in an autoclave, and so the bead extent 9 of the starting material is often greater than the bead extent 9 on the cured planar component.

In FIG. 3, the strands 12 are aligned parallel to one another, but surrounded by a mesh-like supporting structure 10, which bundles the strands 12. The supporting structure 10 may be formed, for example, by a plurality of fibers of glass or aramid. While in FIG. 3 the supporting structure is configured in the manner of a woven fabric or a braiding or wrapping, FIG. 4 shows the arrangement of the strands 12 aligned parallel to one another on a planar textile base structure 14, the fibers 13 of the supporting structure 10 reaching over the strands 12 and being bonded with the base structure 14 (for example comprising carbon fibers, polymer fibers and/or glass fibers). These three configurational variants of the reinforcing bead 8 can be handled very easily during production, and so can be positioned in a dimensionally stable and exactly fitting manner onto the desired location of the partial areas of the planar component. This applies in particular in the case where the reinforcing beads and/or the (layers of the) surface area are already preimpregnated with resin, so that as a result the positioning on the surface area is made easier.

A further planar component 1 is then perspectively represented in FIG. 5. It can be seen that the surface area 3 is subdivided on both sides 15 into a plurality of partial areas 7 by webs 5. In the case of this configurational variant, reinforcing beads 8 are additionally provided on the same side 15 as the webs 5. However, the arrangement takes place in this way such that two crossing reinforcing beads 8 are provided in each partial area 7, arranged in each case diagonally in a straight line to the limits of the partial areas 7.

FIG. 6 then illustrates an aircraft 2 in the form of a passenger airplane, various planar components 1 that can now be provided by the invention with significantly reduced weight being highlighted. Thus, for example, the planar component 1 forms flow surfaces 16 or components of the fuselage 17. In addition, for example, components of the outer skin of the engines and/or the nose of the aircraft 2 may also be produced in this way. It can be clearly seen that the large-area, primary structural components of the aircraft 2 can already be produced by the proposed method, it also being possible for the weight of the aircraft 2 to be reduced significantly. The accompanying low fuel consumption and/or the higher payload are significant advantages of the invention.

### LIST OF DESIGNATIONS

1 Planar component
2 Aircraft
3 Surface area
4 Material thickness
5 Web
6 Web height
7 Partial area
8 Reinforcing bead
9 Bead extent
10 Supporting structure
11 Layer
12 Strand
13 Fiber
14 Base structure
15 Side
16 Flow surface
17 Fuselage

1. Planar component of an aircraft, made of fiber-reinforced composite material, which forms a surface area with a material thickness and is configured with at least one reinforcing bead of a predetermined bead extent, wherein the extent of a bead is at most 10 mm.

2. Planar component according to claim 1, which has webs with a web height which form partial areas of the planar component, at least one partial area being configured with at least one reinforcing bead of a bead extent which extends over the partial area between the webs.

3. Planar component according to claim 1, in which at least the surface area and the at least one reinforcing bead are of a monolithic configuration.

4. Planar component according to claim 1, in which a number of reinforcing beads of a partial area are superposed.

5. Planar component according to claim 1, in which the bead extent corresponds at least to the material thickness and is less than the web height.

6. Planar component according to claim 1, in which at least one reinforcing bead is surrounded by a supporting structure.

7. Method for producing a planar component of an aircraft, comprising at least the following steps:
a) forming a surface area by laminating a number of layers of a curable material;
b) arranging at least one reinforcing bead of a curable material on the surface area,
c) curing the surface area and the at least one reinforcing bead together to form a monolithic planar component.

8. Method according to claim 7, in which the at least one reinforcing bead is provided by at least one of the following processes:
twisting a plurality of strands of the curable material;
bundling a number of strands of the curable material;
fixing a plurality of strands of the curable material in relation to one another;
arranging a plurality of strands of the curable material on a supporting structure.

9. Method according to claim 7, in which the curable materials of the layers and of the at least one reinforcing bead are impregnated with resin in steps a) and b).

10. Method according to claim 7 to, in which step c) is carried out in an autoclave.

11. Aircraft, having at least one planar component according to claim 1.

12. Aircraft having at least one planar component produced by a method according to claim 7.
